(19) United States
(12) Patent Application Publication
(10) Pub. No.: US 2005/0166723 A1
(43) Pub. Date: Aug. 4, 2005

(54) Basin wrench extension handle

(76) Inventor: Christopher H. Sheek, Rancho Cordova, CA (US)

Correspondence Address: Mark C. Jacobs, Esq., 3033 El Camino Avenue, Sacramento, CA, 95821-6014, US

(21) Appl. No.: 10/768,248

(22) Filed: Feb. 2, 2004

(51) Int. Cl. B25B 23/16

(52) U.S. Cl. 81/413

(57) ABSTRACT

A basin wrench extension handle which is a tubular member, either straight elongated or elongated with a 40 to 50 degree bend at about the midpoint, and under 16 inches in length. The tubular member is closed at one end and has a threaded bore near the open end, in which threaded bore is a thumbscrew. When the handle of a conventional basin wrench is disposed in the tubular member, and the thumbscrew tightened, better leverage for rotational movement to loosen a nut or plumbing fitting will be had by the user.

### FIELD OF THE INVENTION

This application relates to an extension handle attachment to a conventional basin wrench to increase the leverage of the user by extending the handle a greater distance from the point of attachment to the basin wrench arm to render rotation easier.

### BACKGROUND OF THE INVENTION

When plumbers or handymen are called upon to clear out drains, or to change plumbing piping, especially under a sink or in other cramped quarters, the chore often proves difficult. This is so because waterline connections and the nuts on faucets can “freeze in place” or rust in place. This renders removal quite difficult, the use of an oversized basin wrench may not solve the problem, as the curled head might not fit correctly on the problem pipe of nut. Thus there is a need for a tool that will help the plumber or handyman achieve a mechanical advantage in his or her battle to loosen nuts or other plumbing fittings. This tool solves that need easily and quickly and at low cost. It permits the removal of fittings and nuts easily and quickly with no learning curve.

The invention accordingly comprises the device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### SUMMARY OF THE INVENTION

An elongated tubular member, straight in one embodiment and having a single bend at near the midpoint along the length in a second embodiment, open at one end and capped off at the other end. Near the open end, a threaded bore is disposed into the tubular member and a thumbscrew is threadedly engaged in this bore for tightening upon the handle of a conventional basin wrench when inserted in te tubular member open end. The second curve containing embodiment permits the device to be used in tight quarters under sinks, where the full elongation might inhibit rotation of the handle of the wrench disposed in the extension tool of this invention.

It is an object therefore of this invention to provide a basin wrench handle receiving device to allow a user to gain further leverage than by merely trying to rotate the handle of the wrench.

It is a second object to provide a basin wrench handle extension that quickly and easily attaches to the handle of a basin wrench.

It is a third object to provide a basin wrench extension handle that is suitable for use in tight places such as under a sink.

Other objects of the invention will in part be obvious and will in part appear hereinafter.

### BRIEF DESCRIPTION OF THE FIGURES

FIG. 1 is a perspective view of a common basin wrench.

FIG. 2 is a perspective view of the first embodiment of this invention.

FIG. 3 is a perspective view of the second embodiment of this invention.

FIG. 4 is a bottom elevational view of the first embodiment.

FIG. 5 is a bottom elevational view of the second embodiment.

FIG. 6 a top elevational view of the second embodiment.

FIG. 7 is a close-up part sectional view of the device of this invention having received the handle or cross member of the basin wrench.

### DESCRIPTION OF THE PREFERRED EMBODIMENT

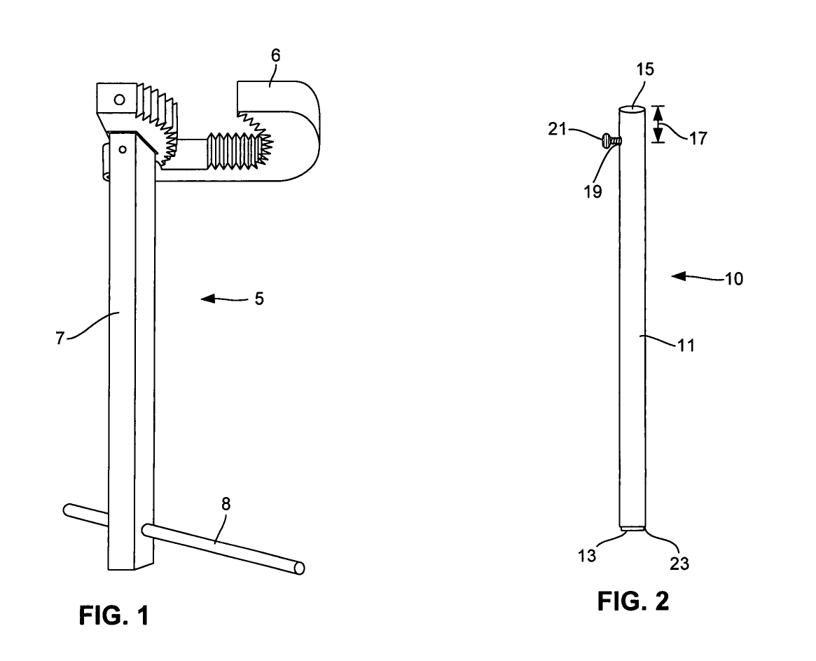

In FIG. 1 there is shown a perspective view of a conventional prior art basin wrench 5 having a head 6, an arm 7 and a cross member 8, which cross member is also referred to as a handle. It is the handle 8 that engages the device of this invention.

The discussion concerning the invention commences with FIG. 2, an elevational view of the first embodiment 10, of this invention. Here the device 10 is seen to comprise an elongated tube 11, ranging from about ten inches in length to about sixteen inches in length and about inches in interior diameter. At a suitable location 17 inward from the open end 15, along the length of the tube 11, a threaded bore 19 is disposed at a 90-degree angle to the length of the tubing. In practice this location can vary from about ½ to 1.00 inch from the open end of the tube, though a further inward distance in would work as well. A thumbscrew 21 is disposed in said bore 19 for retention of a leg of the basin wrench, not seen in this view. The open end 17 of the device 10 is the end in which the handle 8 of the wrench 5 is inserted. Device 10 also includes a rubber cap 13 at the opposite end of the tube 11. Cap 13 prevents injury to the user, and prevents the hand from slipping down off the closed end 23 of the tube 11 of the device 10. An optional rubber grip 25 may overlie the tube 11, as is shown in the close-up view FIG. 7 to prevent hand slippage.

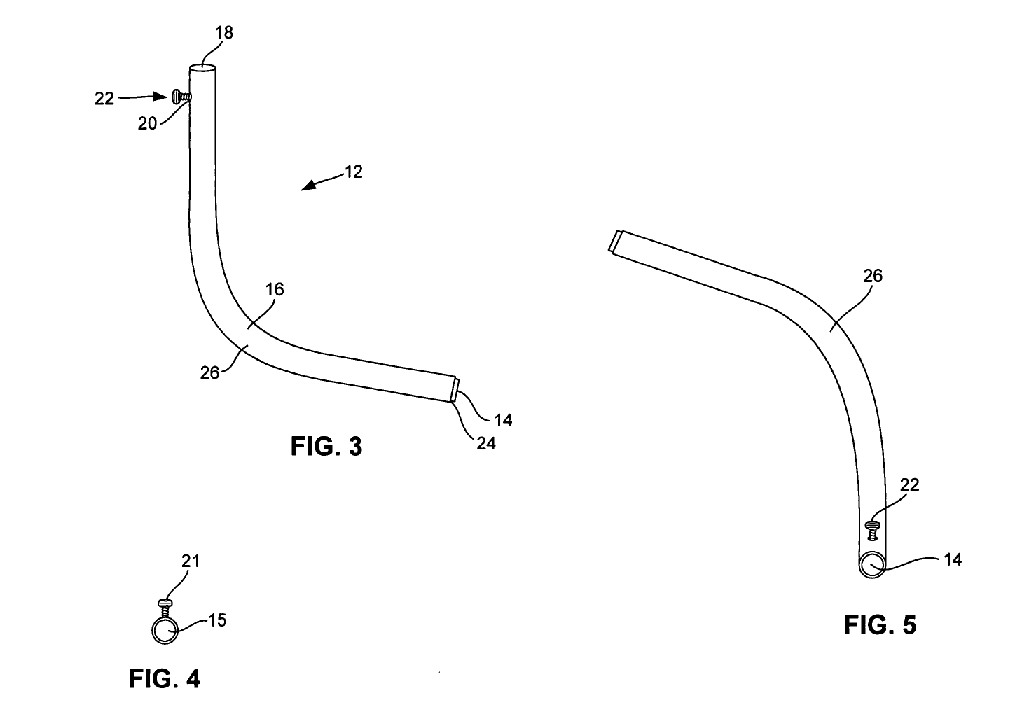

In FIG. 3, the same device is shown but in a different configuration. Here device 12 instead of being a straight elongated tube 11, the tube, designated 12, has a bend in it, ranging between 40 and 50 degrees, with about 42 degrees being one that provides good results. The curve commences at a point about three inches inward from the open end of the tubular member. The second configuration, also of the same internal diameter, can vary in length from about ten inches to sixteen inches with thirteen being the preferred length. In this embodiment the open end for insertion of the handle 8 is designated 18, while the threaded bore and thumbscrew are 20 and 22 respectively. The closed end 24 is covered over by and cap 14. Though shown here, the a grip similar to overlying grip 25 shown for the first embodiment may be employed with this version of the tool as well.

In FIG. 4 the open end 15 of the tube 11 is seen with the thumbscrew 21 in place. Threaded bore 19 though present is not seen.

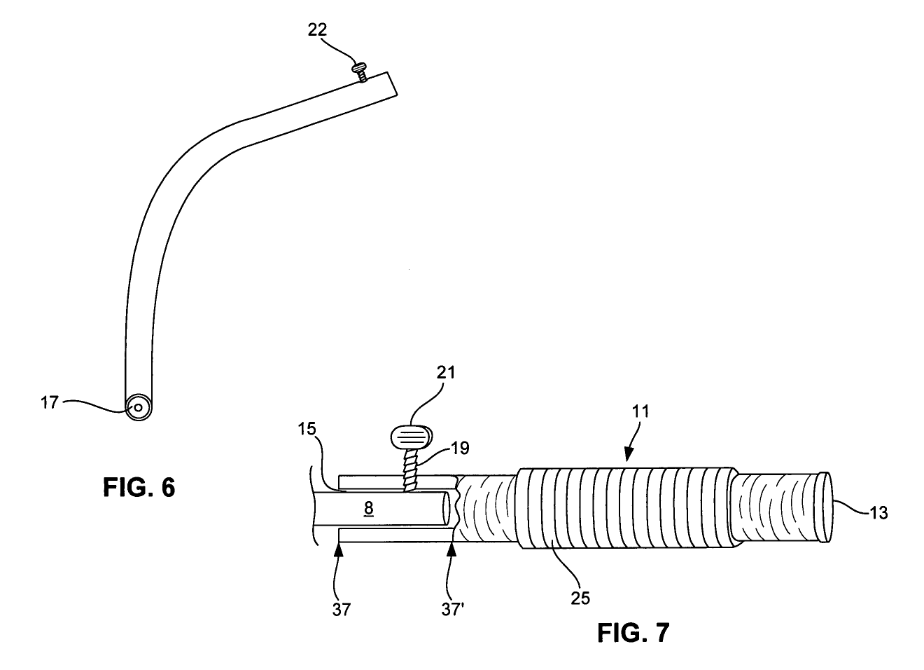

FIG. 5 is a view similar to FIG. 4 but for the second embodiment. Here the open end 14 is seen, as is the thumbscrew 22. The bend point 26 is also seen. FIG. 6 is an elevational view forming the second or closed end of the second embodiment. Thus rubber end cap 17 is visible and the thumbscrew is distant from the viewer.

In FIG. 7 a closeup view is seen with the forward portion between points 37 and 37′ of the device shown in cutaway. Only handle 8 is seen of the basin wrench shown in FIG. 1. The handle 8 is shown inserted almost full length into the open end of the device; here end 15, since the device shown is the straight elongated unit 10. Rubber grip 25 is seen overlaying the tubular section 11. This grip may extend for but a few inches or may extend the entire length from the thumbscrew to the rear-closed end of the device as may be desired. A cap 13 may be frictionally applied or threaded onto external threads, if present, on end 23 of the tube 11.

It is known that the basin wrench handle is only a few inches long, and if the nut to be loosened is rusty or old, it is often next to impossible to pull or push handle 8 to rotate the head 6 disposed on the nut in question. But by disposing almost all of the exposed handle—the unexposed part of the hand is within the arm of the wrench, see FIG. 1, within the open end of the device, and then tightening the thumbscrew to prevent removal, increased leverage can be had to rotate the handle 8 by gripping the round larger diameter and longer tube section 11 of the first embodiment, or the tube section 16 of the second embodiment.

The second embodiment of this invention is employed in cramped quarters, such as under a sink where other pipes or even household articles may be stored.

While the thumbscrew is located at a location close to the open end, with about ¾ inch therefrom being preferred, the fact that the body of this device is a tube permits almost the entire handle 8 of the basin wrench 5 to extend into the tubing, well beyond the thumbscrew. Typically, a basin wrench's handle 8 is about four inches long, which renders grasping it and then rendering a rotational force on it difficult in some situations especially since the diameter is usually about ⅛ inch to 3/16 inch in diameter, rendering grasping difficult.

While a tubular interior diameter of about inch is suggested, this is based upon a believed diameter of about ¼ inch for the typical handle 8 of a basin wrench. Obviously, if the handle 8 is of a larger diameter, then larger interior diameter tubing is required for the body of the device, be it 11 or 16. The thumbscrew is tightened down by rotation upon the basin wrench handle 8, to retain it within the device's tubular member, which is of course of a greater diameter than that of handle 8.

Since certain changes may be made in the described apparatus without departing from the scope of the invention herein involved, it is intended that all matter contained in the above description and shown in the accompanying drawings shall be interpreted as illustrative and not in a limiting sense.

1. A tool for extending the handle of a basin wrench, which tool comprises, an elongated tubular member, having a uniform circular interior cross-section open at a first end and a second end, and having a threaded bore near the open first end of the tubing, in which threaded bore is disposed a thumb screw, which will impact and retain a basin wrench handle when tightened upon the basin wrench handle inserted into the open end of the tubing past the thumb screw.

2. The device of claim 1 wherein the elongated tubular member has a single bend in it of between 40 and 50 degrees.

3. The device of claim 2 wherein the bend is 42 degrees and the device is about 13 inches long.

4. The device of claim 1 wherein the device is about 13 inches long, and the tubular member is of about 1 inch in interior diameter.

5. The device of claim 1 wherein the tubular member is steel and the threaded bore is located at a point between ½ inch and 1 inch from the open end of the tubular member.

6. The device of claim 1 wherein the overall length of the device is between 12 and 16 inches in length, and the thumbscrew is located at about ¾ inch in from the open end of the tubular member.

7. The device of claim 1 wherein a rubber grip overlies at least a portion of the tubular member between the thumbscrew and the second end of the tubing.

8. The device of claim 7 wherein the second end of the device is closed off by a fixed cap.

9. The device of claim 1 wherein the second end of the device is closed off by a fixed cap.

10. A tool for extending the handle of a basin wrench, which tool comprises, an elongated tubular member, open at a first end and preferably closed off at a second end, and having a threaded bore near the open first end of the tubing, in which threaded bore is disposed a thumb screw, which will impact and retain a basin wrench handle when inserted into the open end of the tubing past the thumb screw and wherein the elongated tubular member has a single bend in it of about 42 degrees commencing at a point about 3 inches in from the open end of the tubular member.

11. The device of claim 10 wherein the device is about 13 inches long, and the tubular member is of about 1 inch in interior diameter.
